(19) United States
(12) Patent Application Publication
(10) Pub. No.: US 2009/0281947 A1
(43) Pub. Date: Nov. 12, 2009

(54) METHOD AND SYSTEM FOR MOBILE COMMERCE

(75) Inventor: Yariv EREL, Ramat Efal (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD., Tel Aviv (IL)

(21) Appl. No.: 12/115,885

(22) Filed: May 6, 2008

(51) Int. Cl. G06Q 40/00; H04M 1/00

(52) U.S. Cl. 705/44; 455/558; 705/35

(57) ABSTRACT

An authorization subscriber identification module card, including: (a) a subscriber identification module chip; and (b) a near field communication chip, connected to the subscriber identification module chip, wherein the near field communication chip is adapted to update a balance value in a memory of the authorization subscriber identification module card in response to balance updating information, and to transmit a near field communication confirmation transmission to an external system; wherein the authorization subscriber identification module card is further adapted to provide identification information to a charging authority server; to receive a balance updating information from the charging authority server; and to update the balance value in response to charging information.

### FIELD OF THE INVENTION

The invention relates to methods and systems for mobile commerce.

### BACKGROUND OF THE INVENTION

The Mobile Commerce domain (i.e. the use of a mobile device for financial transactions where the mobile device is used for authentication) can be divided into two different domains: proximity domains (i.e. transactions that require mobile terminal proximity, e.g. FeliCa); and remote domains (i.e. transactions which do not require mobile terminal proximity. E.g. ringtones downloads). By way of example, proximity payments are often used in the mass transportation business, where the saving of a mere second for each user waiting in line could have a significant effect.

The notion of mobile proximity commerce involves users equipped with mobile phones (or other mobile devices, such as a personal digital assistants; PDAs) that are capable of communicating in a proximity way, such as the one elaborated herein. The user interface for conducting a mobile proximate transaction is relatively simple. The mobile device is placed against (or in the immediate proximity of) a dedicated reader, and once authorized the transaction is carried out, (which conveniently is followed by an action, such as the provision of a commodity or a service, e.g. an opening of a train entrance gate, etc).

However, prior solutions of mobile proximity commerce suffer from significant drawbacks in the field of security, as they tend to turn the mobile device (e.g. the cellular phone) into a real ‘cash machine’.

As mobile devices (and especially cellular phones) are generally associated with mobile network operators (MNOs), prior solutions turn to the MNO as transactions authorizer. It is believed that in the future mobile proximity payments will become very popular, but that the role of the MNO in such transactions will become minimal.

Mobile proximity commerce, which is usually implemented using near field communication (NFC), can be put into practice in several ways. In a first way, a Smartcard and an NFC component are embedded in the mobile device (e.g. in the handset of the cellular phone), in a fashion similar to the architecture used in DoCoMo's FeliCa handsets and which has been dominant in trials conducted in the US and Germany. In these trials the shell of Nokia's 3220 has an integrated smartcard and NFC component. The security aspects according to such an implementation are typically handled by the participating credit card companies.

In a second way, a smartcard resides on the SIM card with the NFC component embedded in the mobile device (e.g. in the handset of the cellular phone). Is it however known to those skilled in the art that prior attempts in implementing this architecture fail to accommodate simultaneous communication from the SIM card and NFC reader without introducing a delay that is considered to be unacceptable for use in time critical applications, such as ticketing. The security aspects according to such an implementation are typically handled by the participating credit card companies.

In a third way, a Smart Memory Card (SMC) that contains the smartcard and the NFC component is embedded in the mobile device (e.g. in the handset of the cellular phone). This solution allows a variety of different companies to issue their own branded payment applications directly to their customers via an SMC which can be inserted and removed whenever the application is required. The security aspects according to such an implementation are typically handled by the participating credit card companies.

There is a great need for a reliable and simple means for mobile device based proximity payments which incorporate a built in secure, provisional based system, which conveniently complies with standards accepted in the industry, such as the standards required by the major credit card companies.

### SUMMARY OF THE INVENTION

An authorization subscriber identification module card, including: (a) a subscriber identification module chip; and (b) a near field communication chip, connected to the subscriber identification module chip, wherein the near field communication chip is adapted to update a balance value in a memory of the authorization subscriber identification module card in response to balance updating information, and to transmit a near field communication confirmation transmission to an external system; wherein the authorization subscriber identification module card is further adapted to provide identification information to a charging authority server; to receive a balance updating information from the charging authority server; and to update the balance value in response to charging information.

A method for mobile commerce, the method includes: (a) providing identification information to a charging authority server; (b) receiving balance updating information from the charging authority server; (c) updating a balance value in a memory of an authorization SIM card, in response to the balance updating information; (d) updating the balance value in response to charging information; and (e) transmitting a near field communication confirmation transmission to an external system.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 is a block diagram of an authorization subscriber identification module (SIM) card, according to an embodiment of the invention;

FIG. 2 illustrates a method for mobile commerce, according to an embodiment of the invention; and

FIG. 3 illustrates a method for mobile commerce, according to an embodiment of the invention.

### DETAILED DESCRIPTION OF THE DRAWINGS

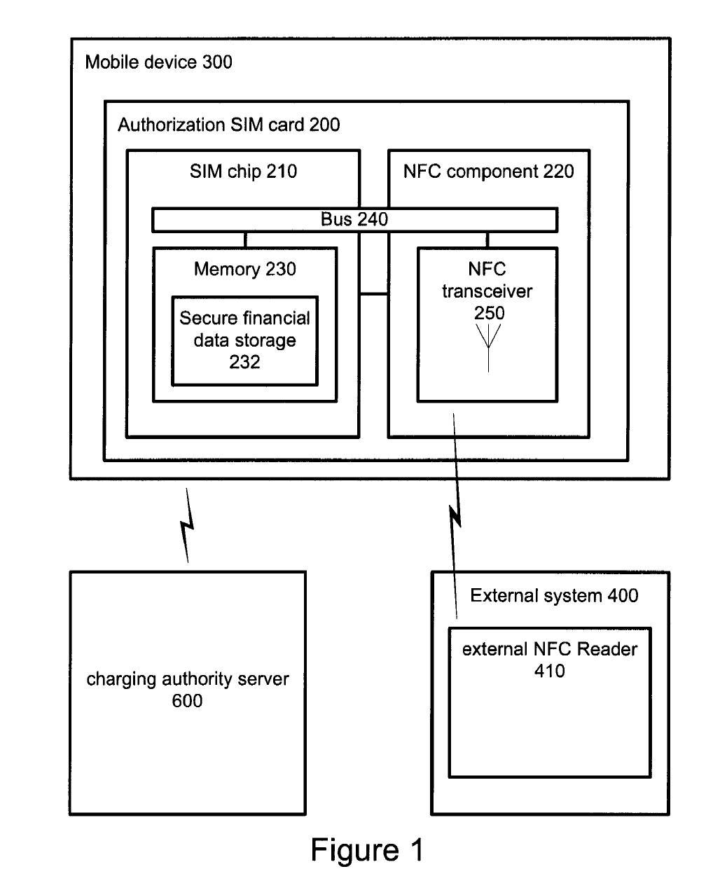

FIG. 1 is a block diagram of authorization subscriber identification module (SIM) card 200, according to an embodiment of the invention. Authorization SIM card includes SIM chip 210 and near field communication (NFC) component 220, that is connected to SIM chip 210 and which is adapted: (a) to update a balance value in memory 230 of authorization SIM card 200 in response to charging information, and (b) to transmit a NFC confirmation transmission to external system 400.

Authorization SIM card 200 is adapted: (a) to provide identification information to charging authority server 600 (which conveniently belongs to a charging authority). It is noted that according to one preferred embodiment of the invention, the charging authority is a credit card company, and charging authority server 600 is a credit card company server; (b) to receive balance updating information from charging authority server 600; and (c) to update the balance value in response to the balance updating information.

It is noted that conveniently, authorization SIM card 200 is compatible to any GSM, or CDMA mobile device 300 (such as GSM, or WCDMA cellular phone, or another mobile device 300 which is compatible with such SIM cards). It is further noted that, therefore, no physical changes (and conveniently no other changes) are necessary to mobile device 300 in order for authorization SIM card 200 to operate.

Additionally, it is noted that authorization SIM card 200 conveniently supports all the features of a standard SIM card (conveniently by SIM chip 210 and by additional standard components and interfaces). The unique features of authorization SIM card 200 described herein are conveniently offered on top of the standard features, known in the industry.

It is clear to a person who is skilled in the art that authorizing SIM card 200 enables the conversion of any known SIM based mobile device to an NFC mobile device (thus suitable for mobile commerce) simply by replacing the SIM card.

Conveniently, NFC component 220 includes NFC Transceiver 250, which facilitates two way communications (it is noted that the NFC protocol is a two way communication protocol) between authorization SIM card 200 and an external NFC Reader 410 of external system 400. Bus 240 conveniently connects NFC transceiver 250 to memory 230 in a real time connection.

It is noted that, conveniently, memory 230 is a legacy SIM storage, that is adapted to support standard SIM operations, as well as allocating (and conveniently also managing) the necessary storage requirements for the operation of authorization SIM card 200 as disclosed herein. It is noted that memory 230 can be implemented by multiple memory units, some of which resides inside SIM chip 210, and others included elsewhere in authorization SIM card 200. However, it is noted that conveniently memory 230 is the memory of SIM chip 210, wherein a dedicated area (e.g. secure financial data storage 232) is reserved for user financial credential etc, as disclosed below.

Memory 230 conveniently stores user financial credentials (e.g. in secure financial data storage 232) that are associated with the user of authorization SIM 200, as well as a balance status which indicates the charging credit of the user (usually which sum of money is currently available for charging using authorization SIM card 200, without requesting additional charging credit from charging authority server 600 which belongs to a charging authority). Conveniently, the user financial credentials store the user identification according to a protocol of the charging authority, and can be updated as necessary by the charging authority.

It is noted that, according to a preferred embodiment of the invention, the charging authority is a credit card company, wherein the protocol for the user financial credentials is a credit card company protocol.

As will be clear to a person who is skilled in the art, the authorization SIM cards and the methods for mobile commerce herein disclosed grant to the charging authority full control over the mobile commerce carried out by authorization SIM card 200. Therefore, each charging authority offering the use of such authorization SIM cards and methods (e.g. different credit card companies) can encrypt the user financial credentials in its own way, without having to disclose it to another party (such as the MNO).

It is noted that SIM chip 210 facilitates connectivity to a mobile network (such as the connectivity facilitated by standard SIM cards). Through the connectivity to the mobile network, the mobile network operator (MNO) of the mobile network enables the charging authority (and especially, according to an embodiment of the invention, credit card companies) to provision the user (i.e. to provide charging capabilities) on their own, without involving the MNO, thus maintaining in the domain of the charging authority sensitive information pertaining to the user and to the charging thereof, such as the user credentials, an encryption key, and additional relevant user information, according to different embodiments of the invention.

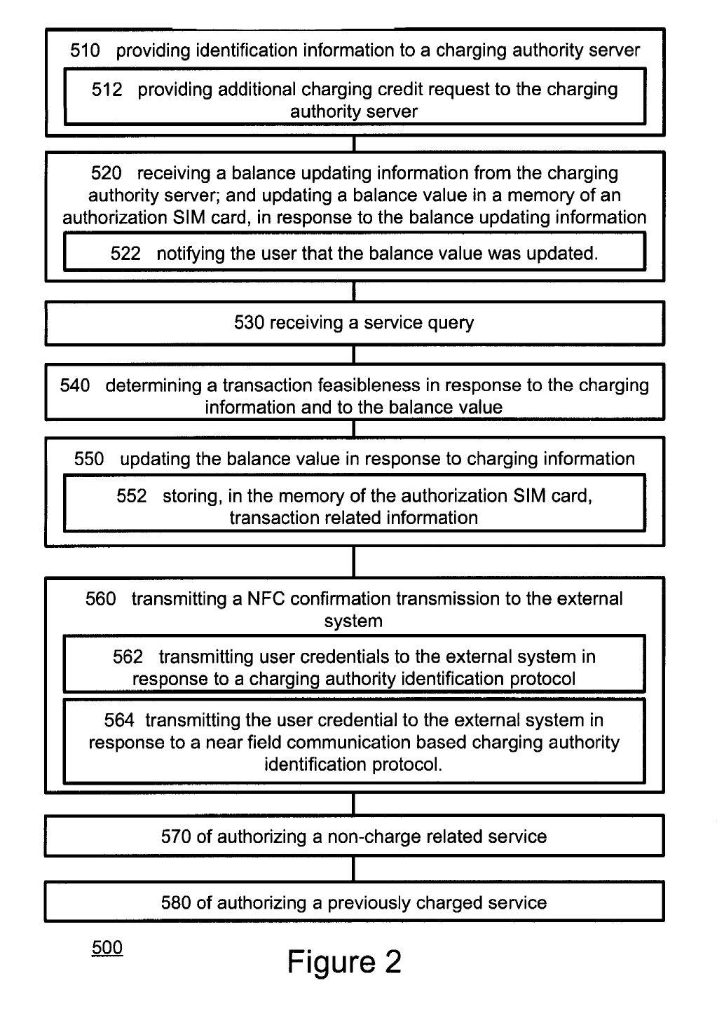

The following description includes description of different embodiments of authorization SIM card 200. It is noted that authorization SIM card 200 is conveniently adapted to carry out method 500 (as shown in FIG. 2) for mobile commerce disclosed below, and that the disclosure of method 500 may be beneficial when reviewing different embodiments of authorization SIM card 200.

As aforementioned, authorization SIM card 200 is adapted to provide identification information to charging authority server 600, wherein the identification information is conveniently used to identify the user of the authorization SIM card 600 as an authorized user, for the provision of additional charging credit to authorization SIM card 200. It is noted that conveniently, a charging authority to which charging authorization server 600 belongs charges an account associated with the user in a sum responsive to the additional charging credit provisioned.

It is noted that according to different embodiments of the invention, different types of identification information are provided by authorization SIM card 200. By way of example only, and not intending to limit the scope of the invention in any way, some of the types of identification information are: voice samples suitable for voice recognition (wherein the voice samples are usually provided via a voice communication sub-system of mobile device 300); user authorization code (which is conveniently provided either by a user authorization code provision text message, using touch tone signaling, or in an internet protocol (IP) session), and so forth. It is noted that according to an embodiment of the invention, the identification information is provided in response to recognition of the user using one or more biometric recognition components of mobile device 300.

According to an embodiment of the invention, authorization SIM card 200 is further adapted to provide additional charging credit request to charging authority server 600, which indicates the additional charging credit requested by the user. It is noted that in such embodiments of the invention, the additional charging credit request conveniently accompanies the provided identification information.

As aforementioned, authorization SIM card 200 is adapted to receive the balance updating information from charging authority server 600; and to update the balance value in response to the balance updating information. It is noted that charging authority server 600 conveniently authorizes additional charging credit in response to the identification information, and to additional user associated information, such as account balance, limited balance credit, withdrawal authorization (e.g. according to embodiments of the invention in which authorization SIM card 200 is utilized for cash withdrawals) and so forth. In addition to obvious reasons of the charging authority, this can be of further use for limiting the use of the authorization SIM card by children, employees, etc.

It is noted that according to different embodiments of the invention, the receiving of the balance updating information can be carried out using different types of balance updating information reception, such as a dedicated text message, or over the air (OTA) provisioning, and so forth. It is noted that conveniently, the receiving of the balance updating information is carried out by communication capabilities of mobile device 300, other than those of NFC component 220 (i.e. over the air transmission). However, according to an embodiment of the invention, the providing of the identification information and/or the additional charging credit request, and/or the receiving of the balance updating information can also be carried out in a NFC-communication-capable charging station, that communicates with charging authority server 600.

According to an embodiment of the invention, authorization SIM card 200 is adapted to notify the user that the balance value was updated. According to an embodiment of the invention, the notifying is carried out by way of a textual (or other) message sent by charging authority server 600. According to an embodiment of the invention, the notifying is carried out by authorizing SIM card 200 (e.g. by sending a message to be displayed on a screen of mobile device 300, etc).

It is noted that in different situations, a receiving of balance updating information from charging authority server 600 can be carried out without previously providing identification information by authorization SIM card 200. For example, in case the charging authority detects (or is informed of) a fraud pertaining to the use of authorization SIM card 200, it can choose to block further transactions by authorization SIM card 200, and so forth.

In the case that the charging authority decides to stop the service (e.g. based on fraud or credit score), it is able to do so immediately on its own, without waiting for the MNO. It is however noted that in such a scenario the MNO should usually be informed by the charging authority, mainly for customer care purposes (the reason for the blocking however doesn't have to be disclosed). It is however clear that in case the MNO is aware of reasons to block or limit the service (e.g. a fraud, a loss of mobile device 300 or stealing thereof) it can notify the charging authority that such an action is desired.

According to an embodiment of the invention, the entire process of updating the balance value is carried out automatically, wherein authorization SIM card 200 is adapted to provide identification information to charging authority server 600 automatically, according to identification information providing criteria (e.g. if the balance value dropped under a predetermined threshold value), and to receive balance updating information which is provided automatically by charging authority server 600, usually in response to charging authority balance updating information providing criteria (e.g. a prepaid value, etc.).

According to an embodiment of the invention, authorization SIM card 200 is adapted to receive a service query, which includes charging information. The service query is conveniently provided by external system 400, which usually belongs to the charge related service provider (such as an automatic vendor machine, public transportation entry controller, internet access point, and so forth).

According to an embodiment of the invention, authorization SIM card 200 is adapted to determine the transaction feasibleness in response to the charging information and to the balance value. That is, authorization SIM card 200 conveniently determines the transaction feasibleness in response to the cost of the service, and to the balance value stored in memory 230. It is noted that, according to different embodiments of the invention, additional parameters could be taken into consideration during the determining of the transaction feasibleness, such as (though not limited to) authorized charge related services.

According to an embodiment of the invention, authorization SIM card 200 is adapted to offer the user (e.g. by suitable display on a screen of mobile device 300, which may be accompanied by sound) to charge authorization SIM card 200 (as discussed above), if the transaction was determined infeasible (this option is usually only offered if the reason to the denial of transaction is insufficient balance value).

As aforementioned, authorization SIM card 200 is adapted to update the balance value in response to the charging information. The balance value indicates the charging credit now available to the user of authorization SIM card 200. Once a transaction is carried out (usually in response to a provision of a commodity or a service), the respective cost of the commodity or service is to be deducted from the balance value. Conveniently, the updating of the balance value is responsive to the charging information (i.e. to the cost of the service or the commodity).

According to an embodiment of the invention, authorization SIM card 200 is adapted to store in memory 230 transaction related information, such as the commodity or service provided, the respective cost, the time of the transaction, the location of the transaction, and so forth. The transaction related information can be used for future reference, for inclusion in transaction details report provided to the user, and so forth. According to an embodiment of the invention, authorization SIM card 200 is adapted to store transaction service provider information received from external system 400, such as transaction service provider identification code, etc.

As aforementioned, authorization SIM card 200 is adapted to transmit the NFC confirmation transmission to external system 400. The NFC confirmation transmission conveniently informs external system 400 that a charging took place, and that the service or the commodity should be provided to the user, e.g. based on the NFC protocol. Conveniently, the transmitting of the NFC confirmation transmission is responsive to the transaction feasibleness. Conveniently, authorization SIM card 200 is adapted to transmit the NFC confirmation transmission only once confirmation occurs that the balance value was updated.

According to an embodiment of the invention, system 200 is further adapted to transmit user credentials to external system 400 in response to a charging authority identification protocol, prior to transmitting the NFC transmission to external system 400, wherein the charging authority identification protocol is conveniently used to assure external system 400 that the charging is valid, and that the commodity or the service should be provided.

According to an embodiment of the invention, system 200 is adapted to transmit the user credentials to external system 400 in response to an NFC based charging authority identification protocol, which requires only NFC communication, and as such is a quick identification protocol, which is suitable for a transaction in which the short duration of the transaction is crucial (e.g. in mass transportation entry gating systems, etc).

It is noted that, according to an embodiment of the invention, authorization SIM card 200 is adapted to authorize a non-charge related service, such as entry to an entry restricted location, and so forth. This is conveniently carried out by receiving a non-charge related service query, and transmitting a non-charge related NFC confirmation transmission.

According to an embodiment of the invention, authorization SIM card 200 is further adapted to authorize a previously charged service. For example, the user may have booked a flight in advance, wherein a suitable confirmation code was sent to authorization SIM card 200 (either by the credit card company or by the airline). Thus when going through the checking in process, the user can be identified as a ticket owner using authorization SIM card 200. The authorizing of the previously charged service conveniently includes receiving a previously charged service query, and transmitting a previously charged service NFC confirmation transmission (which may include, for example, the suitable confirmation code).

It is noted that, according to an embodiment of the invention, authorization SIM card 200 is adapted to support mobile commerce backed by more than a single charging authority. According to such as embodiment of the invention, authorization SIM card 200 is adapted to provide second identification information to a second charging authority server (not shown); to receive second balance updating information from the second charging authority server; to update a second balance value in memory 230 in response to the second balance updating information; to update the second balance value in response to second charging information; and to transmit a second near field communication confirmation transmission to a second external system (not shown).

This way, the user can utilize mobile device 300, which includes authorization SIM card 200, for mobile commerce using more than one credit card (of one or more credit card companies). According to another utilization, the user can utilize mobile device 300 for mobile commerce using his credit card account as well as an additional non-credit card charging authority, such as of public transportation charging authority, or of an intra-organizational charging authority (e.g. in a dining room, for using copying machines, or any other utilization). It is clear to a person skilled in the art that additional utilizations are applicable in such an embodiment of the invention.

According to an embodiment of the invention, authorization SIM card 200 is adapted to receive an account selection indication (usually from the user, by an input interface of mobile device 300), which specifies the account (with which a balance value is associated) which should be used for mobile commerce. It is noted that in some utilizations this is not necessary, as external system 400 (e.g. one associated with a photo copying machine of the organization) can indicate the preferred account.

It is noted that authorization SIM card 200, similarly to other SIM cards, is conveniently provided to the user by the MNO, and that according to some accepted standards in the industry is a propriety asset of the MNO. It is noted that therefore, usually a providing or a replacement of authorization SIM card 200 needs to be either carried out by the MNO or coordinated with which, in order for mobile device 300 (e.g. a cellular phone) to operate properly in the mobile network.

Additionally, once the user is registered as a client of the charging authority, the MNO should usually be informed (mainly for customer care service, though in some embodiments of the invention dedicated encrypted transmissions between authorization SIM card 200 and charging authority server should be enabled). Note, that while the customer care aspects of the transaction should be held by the charging authority (e.g. the credit card companies), a customers care system of the MNO should usually be informed that the service is alive and potently its status.

Conveniently, authorization SIM card 200 should also be activated by the charging authority, wherein usually authorization SIM card 200 will be associated with a charging account of the user, identification means will be set. According to an embodiment of the invention, additional balance updating criteria will be set, both on the charging authority side (maximal withdrawal frame, etc.) and on authorization SIM card 200 side (e.g. maximum amount to be charged via authorization SIM card 200, etc.).

FIG. 2 illustrates method 500 for mobile commerce, according to an embodiment of the invention. It is noted that, conveniently, method 500 is carried out by an authorization SIM card, such as authorization SIM card 200, and that different embodiment of method 500 are adapted to support different embodiments of authorization SIM card 200 and vice versa, even if not explicitly stated.

Method 500 starts with stage 510 of providing identification information to a charging authority server, wherein the identification information is conveniently used to identify a user of an authorization SIM card an authorized user, for the provision of additional charging credit to the authorization SIM card. It is noted that conveniently, a charging authority to which the charging authorization server belongs charges an account associated with the user in a sum responsive to the additional charging credit provisioned. Conveniently, the charging authority server belongs to a charging authority. It is noted that according to one preferred embodiment of the invention, the charging authority is a credit card company, wherein the charging authority server is a credit card company server.

It is noted that according to different embodiments of the invention, different types of identification information are provided in stage 510. By way of example only, and not intending to limit the scope of the invention in any way, some of the types of identification information are: voice samples suitable for voice recognition (wherein the voice samples are usually provided via a voice communication sub-system of the mobile device); user authorization code (which is conveniently provided either by a user authorization code provision text message, using touch tone signaling, or in an internet protocol (IP) session), and so forth. It is noted that according to an embodiment of the invention, the identification information is provided in response to recognition of the user using one or more biometric recognition components of the mobile device.

It is noted that, according to an embodiment of the invention, stage 510 is accompanied by stage 512 of providing additional charging credit request to the charging authority server, which indicates the additional charging credit requested by the user.

Stage 510 is followed by stage 520 of receiving balance updating information from the charging authority server; and updating the balance value in response to the balance updating information. It is noted that the charging authority server conveniently authorizes additional charging credit in response to the identification information, and to additional user associated information such as account balance, withdrawal authorization and so forth. In addition to obvious reasons of the charging authority, this can be of further use for limiting the use of the authorization SIM card by children, employees, etc.

It is noted that according to different embodiments of the invention, the receiving of stage 520 can be carried out using different types of balance updating information reception, such as a dedicated text message, and so forth. It is noted that conveniently, the receiving of stage 520 is carried out by communication capabilities of the mobile device, other than those of a near field communication (NFC) component that is included in the authorization SIM card (Over the Air transmission). However, according to an embodiment of the invention, the providing of stage 510 and the receiving of stage 520 can also be carried out in an NFC communication capable charging station.

According to an embodiment of the invention, stage 520 includes stage 522 of notifying the user that the balance value was updated. According to an embodiment of the invention, the notification is carried out by way of a textual (or other) message sent by the charging authority server. According to an embodiment of the invention, the notifying is carried out by the authorizing SIM card (e.g. by sending a message to be displayed on a screen of the mobile device, etc).

It is noted that in different situations, receiving of balance updating information from the charging authority server can be carried out without previously providing identification information. For example, in case the charging authority detects (or is informed of) a fraud pertaining to the use of the authorization SIM card, it can choose to block further transactions by the authorization SIM card, etc.

In the case that the charging authority decides to stop the service (e.g. based on fraud or credit score), it is able to do so immediately on its own, without waiting for the MNO. It is however noted that in such a scenario the MNO should usually be informed by the charging authority, mainly for customer care purposes (the reason for the blocking however doesn't have to be disclosed). It is clear however, that in case the MNO is aware of reasons to block or limit the service (e.g. a fraud, a loss of the mobile device or stealing thereof) it can notify the charging authority that such an action is desired.

According to an embodiment of the invention, the entire process of updating the balance value is carried out automatically, wherein stage 510 of providing identification information to a charging authority server is carried out automatically according to identification information providing criteria (e.g. if the balance value dropped under a predetermined threshold value), and the balance updating information received in stage 520 is provided automatically by the charging authority server, usually in response to charging authority balance updating information providing criteria (e.g. a prepaid value, etc.).

Method 500 conveniently continues with stage 530 of receiving a service query, which conveniently includes charging information. The service query is conveniently provided by an external system, which usually belongs to the charge related service provider (such as an automatic vendor machine, public transportation entry controller, internet access point, and so forth).

Stage 530 is conveniently followed by stage 540 of determining transaction feasibleness in response to the charging information and to the balance value. That is, the authorization SIM card conveniently determines the transaction feasibleness in response to the cost of the service, and to the balance value available in the authorization SIM card. It is noted that, according to different embodiments of the invention, additional parameters could be taken into consideration during the determining of the transaction feasibleness, such as (though not limited to) authorized charge related services.

The authorized charge related services may enable, for example, a platinum customer that didn't charge his authorization subscriber identification module card (e.g. included in a cellular phone of the platinum customer) and finds out about it when in a train station, to get a ‘faith ride’ while receiving an SMS message that he can go since is a platinum member. On the other hand, some services may not be provided to some users (e.g. users under 16 years of age), even if the balance value available in the authorization SIM card exceeds the cost of the service.

It is noted that, according to an embodiment of the invention, if the transaction was determined infeasible, the user is offered to go through stages 510 and 520, in order to recharge the authorization SIM card with additional charging credit (this option is usually only offered if the reason to the denial of transaction is insufficient balance value).

If transaction feasibleness is confirmed in stage 540, then method 500 continues with stage 550 of updating a balance value in response to charging information. The balance value indicates the charging credit now available to the user of the authorization SIM card. Once a transaction is carried out (usually in response to a provision of a commodity or a service), the respective cost of the commodity or service is to be deducted from the balance value.

According to an embodiment of the invention, stage 550 includes stage 552 of storing, in a memory of an authorization SIM card, transaction related information, such as the commodity or service provided, the respective cost, the time of the transaction, the location of the transaction, and so forth. The transaction related information can be used for future reference, for inclusion in transaction details report provided to the user, and so forth.

According to an embodiment of the invention, the storing of the transaction related information includes storing transaction service provider information, such as transaction service provider identification code, etc.

Conveniently, the updating of the balance value is responsive to the charging information (i.e. to the cost of the service or the commodity).

Stage 550 is followed by stage 560 of transmitting an NFC confirmation transmission to the external system. The NFC confirmation transmission conveniently informs the external system that a charging took place, and that the service or the commodity should be provided to the user.

Conveniently, the transmitting of the NFC confirmation transmission is responsive to the transaction feasibleness. Conveniently, the NFC confirmation transmission is carried out only once the balance value was confirmed updated.

According to an embodiment of the invention, the transmitting of the near field communication confirmation transmission to the external system is preceded by stage 562 of transmitting user credentials to the external system in response to a charging authority identification protocol, which is conveniently used to assure the external system that the service or the commodity should be provided, wherein the charging authority identification protocol may require at least one instance of communication to and from the external system.

According to an embodiment of the invention, stage 562 includes stage 564 of transmitting the user credential to the external system in response to an NFC based charging authority identification protocol, which requires only NFC communication. It is noted that, according to some embodiments of the invention, some of which are disclosed in more detailed a manner in relation to stage 720 of method 700, the charging authority identification protocol may require additional identification stages, such as voice recognition and the like. However, conveniently the charging authority identification protocol requires only NFC communication with the external system, so as to assure a very quick authorization process.

It should be noted that such a charging authority identification protocol conveniently does not require cellular communication, nor any other type of communication but the NFC communication required for the transmission of a service query, of the user credentials, and the like, with the external system.

Obviating the requirement for OTA communication serves two ends. Firstly, the charging authority identification process is far faster than when a communication with the MNO is necessitated (all the communication is carried out instantly between the authorization SIM card and the NFC reader which are only few centimeters apart, and does not require the participation of any third system). Moreover, obviating the requirement for OTA communication also facilitates such an immediate charging process and service providing in places where cellular reception is not available or problematic (e.g. metro stations, underground buildings, elevators, etc.)

It is further noted that according to some different embodiments of the invention, some or all of the charging authority identification process as well as—according to an embodiment of the invention—the transmitting of the NFC confirmation transmission, can be carried before stage 550 of updating the balance value in response to the charging information is carried out.

It should be clear that the charging authority authorization protocol should be disclosed neither to the MNO of the mobile device nor to a manufacturer or a provider of the authorization SIM card, thus increasing the security of the charging process.

According to an embodiment of the invention, method 500 further includes stage 570 of authorizing a non-charge related service, such as entry to an entry restricted location, and so forth. Stage 570 conveniently includes receiving a non-charge related service query, and transmitting a non-charge related NFC confirmation transmission.

According to an embodiment of the invention, method 500 further includes stage 580 of authorizing a previously charged service. For example, the user may have booked a flight in advance, wherein a suitable confirmation code was sent to the authorization SIM card (either by the credit card company or by the airline). Thus when going through the checking in process, the user can be identified as a ticket owner using the authorization SIM card. Stage 580 conveniently includes receiving a previously charged service query, and transmitting a previously charged service NFC confirmation transmission.

It is noted that, according to an embodiment of the invention, method 500 further includes providing second identification information to a second charging authority server; receiving second balance updating information from the second charging authority server; updating a second balance value in the memory of the authorization SIM card, in response to the second balance updating information; updating the second balance value in response to second charging information; and transmitting a second near field communication confirmation transmission to a second external system.

This way, the user can utilize his mobile device, which includes the authorization SIM card, for mobile commerce using more than one credit card (of one or more credit card companies). According to another utilization, the user can utilize his mobile device for mobile commerce using his credit card account as well as an additional non-credit card charging authority, such as of public transportation charging authority, or of an intra-organizational charging authority (e.g. in a dining room, for using copying machines, or any other utilization). It is clear to a person skilled in the art that additional utilizations are applicable in such an embodiment of the invention.

According to an embodiment of the invention, the method includes receiving an account selection indication (usually from the user), which specifies the account (with which a balance value is associated) to be used for mobile commerce. It is noted that in some utilizations this is not necessary, as the external system (e.g. one associated with a photo copying machine of the organization) can indicate the preferred account.

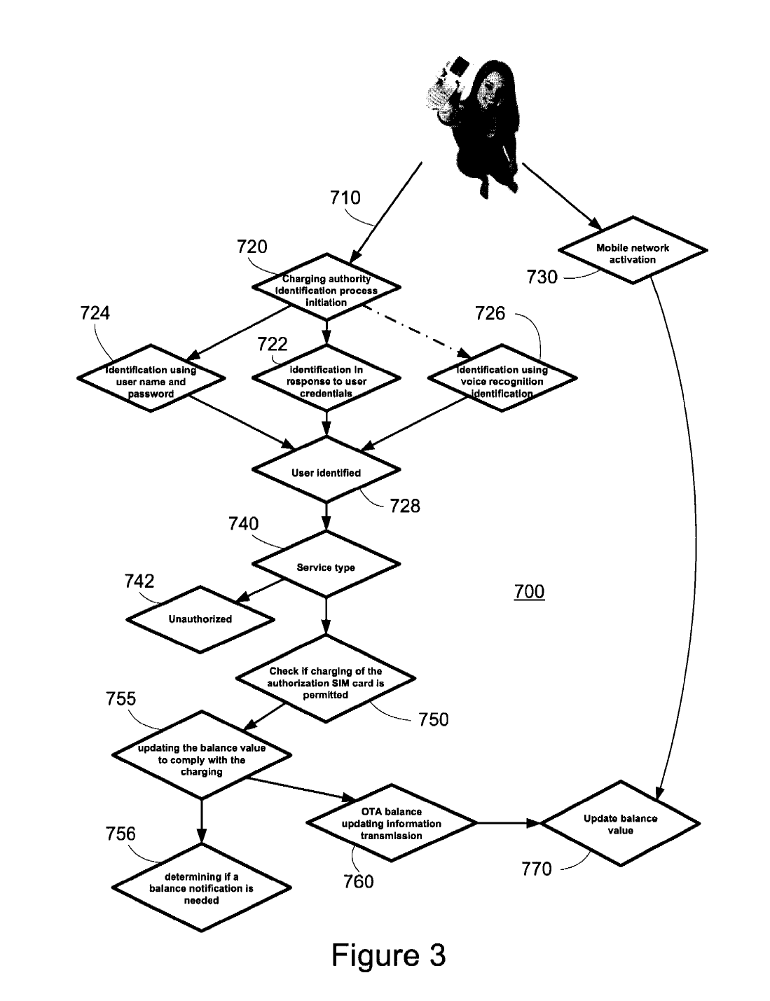

FIG. 3 illustrates method 700 for mobile commerce, according to an embodiment of the invention. It is clear to a person who is skilled in the art that in different implementations of method 700, several of the stages of method 700 are not compulsory, and are carried out only when needed. The transitions in FIG. 3 are illustrated by a solid arrow if the transition is conveniently carried out automatically, and by a broken arrow if the transition is conveniently carried out manually, or requires user intervention. It is however noted that according to some embodiments of the invention, the transitions could be carried out in a fashion other than those illustrated by the arrows of FIG. 3.

Method 700 starts with stage 710 in which the user triggers a mobile commerce session. Conveniently, the triggering of the mobile commerce session is carried out by placing by the user of a mobile device which includes the authorization SIM card next to an NFC reader of the external system (e.g. a mass transit entry gating system).

Stage 710 is followed by stage 720, in which a charging authority identification process is initiated. It should be clear that the charging authority identification process is conveniently handled according to charging authority protocols, which should not be disclosed to the MNO of the mobile device nor to a manufacturer or a provider of the authorization SIM card.

Conveniently, stage 720 includes stage 722 of identification in response to user credentials that are stored in a memory of the authorization SIM card. It should be noted that such an authorization does not require cellular communication, nor any other type of communication, but the NFC communication required for the transmission of a service query, of the user credentials, and the like, with the external system. By way of example, if the authorization SIM card is used to charge a ticketing of a subway train, there may not be cellular reception in the subway station. The activity will occur without any cellular component.

Obviating the requirement for OTA communication serves towards two ends. Firstly, the identification process is far faster than when a communication with the MNO is necessitated (all the communication is carried out instantly between the authorization SIM card and the NFC reader which are only few centimeters apart, and does not require the participating of any third system). Moreover, obviating the requirement for OTA communication also facilitates such an immediate charging process and service providing in places where cellular reception is not available or problematic (e.g. metro stations, underground buildings, elevators, etc.)

While the charging process may be slowed, but for security reasons, stage 720 of the process may include, according to some embodiments of the invention, stage 724 of identification using a user name and password (which are either entered manually by the user, and/or at least partially provided from data stored in the memory of the mobile device), or stage 726 of identification using voice recognition identification. Conveniently, stage 720 leads to stage 728 in which the user is identified (obviously, if the user is not identified as an authorized user, further stages of method 700 are not carried out).

Conveniently, stage 728 is followed by stage 740 of determining a service type to which the user is eligible. Stage 740 may be responsive to information included in the service query received from the external system, but this is not necessarily so. For example, the user may be eligible to a premium service (e.g. a “gold service”, a “platinum service”) which may allow the user to charge more than available according to his balance value up to a known extent, to limit the possibility of a premium user being denied a service. Conveniently, stage 740 is followed by stage 750, unless the user is not authorized to charge according to the determined service type, and potentially also to the information included in the service query (denoted 742).

Method 700 continues with stage 750 of checking if charging of the authorization SIM card is permitted, usually in response to the balance value. If charging of the authorization SIM card is permitted, stage 755 of updating the balance value to comply with the charging is carried out.

Conveniently, method 700 further includes stage 756 of determining if a balance notification is needed, in response to the updated balance value and in response to a balance notification threshold, which is conveniently associated with a small balance value, for indicating to the user that only a limited amount of withdrawals may be facilitated by the authorization SIM card without additional recharging thereof. If balance notification is needed, the user is conveniently notified by a vocal and/or visual alert, and is offered, according to an embodiment of the invention, to recharge his mobile wallet account (e.g. to press a key for authorizing a recharging, to enter a code for authorizing the recharging and so forth).

Had the user selected to recharge his authorization SIM card, stage 760 of transmitting balance updating information in an over-the-air transmission is carried out. Conveniently, the over-the-air transmission also includes transmitting to the MNO information pertaining to the transaction that occurred since the last such transactions history transmission.

It is noted that such transmission of transactions history may occur not only upon recharging of the authorization SIM card, but may also take place in response to other transactions history transmission decision rules, such as (though not limited to) time related decision rules (e.g. on a daily basis), upon querying from the charging authority, and so forth.

Upon receiving the balance updating information by authorization SIM card 200, stage 770 of updating the balance value is carried out.

As disclosed above, the balance value should be also updated from time to time, so as to recharge the authorization SIM card for future transaction. This stage requires wireless OTA communication facilitated by the MNO. In order to recharge the authorization SIM card, stage 730 of management network activation, which conveniently includes the aforementioned stages 510 and 520, is carried out.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. An authorization subscriber identification module card, comprising:
a subscriber identification module chip; and
a near field communication chip, coupled to the subscriber identification module chip, wherein the near field communication chip is adapted to update a balance value in a memory of the authorization subscriber identification module card in response to charging information, and to transmit a near field communication confirmation transmission to an external system;
wherein the authorization subscriber identification module card is further adapted to provide identification information to a charging authority server; to receive balance updating information from the charging authority server; and to update the balance value in response to the balance updating information.

2. The authorization subscriber identification module card according to claim 1, further adapted to transmit user credentials to the external system in response to a charging authority identification protocol prior to transmitting the near field communication confirmation transmission to the external system.

3. The authorization subscriber identification module card according to claim 2, adapted to transmit the user credentials to the external system in response to a near field communication based charging authority identification protocol.

4. The authorization subscriber identification module card, according to claim 1, further adapted to receive a service query that comprises the charging information.

5. The authorization subscriber identification module card according to claim 1, further adapted to determine transaction feasibleness in response to the charging information and to the balance value.

6. The authorization subscriber identification module card according to claim 1, further adapted to store, in the memory of the authorization subscriber identification module card, transaction related information.

7. The authorization subscriber identification module card according to claim 1, further adapted to: provide second identification information to a second charging authority server; receive second balance updating information from the second charging authority server; update a second balance value in the memory of the authorization subscriber identification module card in response to the second balance updating information; update the second balance value in response to second charging information; and transmit a second near field communication confirmation transmission to a second external system.

8. The authorization subscriber identification module card according to claim 1, further adapted to authorize a non-charge related service.

9. The authorization subscriber identification module card according to claim 1, further adapted to authorize a previously charged service.

10. The authorization subscriber identification module card according to claim 1, adapted to provide the identification information to a credit card company server.

11. A method for mobile commerce, the method comprising:
providing identification information to a charging authority server;
receiving balance updating information from the charging authority server;
updating a balance value in a memory of an authorization SIM card, in response to the balance updating information;
updating the balance value in response to charging information; and
transmitting a near field communication confirmation transmission to an external system.

12. The method according to claim 11, wherein the transmitting of the near field communication confirmation transmission to the external system is preceded by transmitting user credentials to the external system in response to a charging authority identification protocol.

13. The method according to claim 12, wherein transmitting of the user credential to the external system is responsive to a near field communication based charging authority identification protocol.

14. The method according to claim 11, further comprising receiving a service query that comprises the charging information.

15. The method according to claim 11, further comprising determining transaction feasibleness in response to the charging information and to the balance value.

16. The method according to claim 11, further comprising storing, in the memory of the authorization SIM card, transaction related information.

17. The method according to claim 11, further comprising providing second identification information to a second charging authority server; receiving second balance updating information from the second charging authority server; updating a second balance value in the memory of the authorization SIM card, in response to the second balance updating information; updating the second balance value in response to second charging information; and transmitting a second near field communication confirmation transmission to a second external system.

18. The method according to claim 11, further comprising authorizing a non-charge related service.

19. The method according to claim 11, further comprising authorizing a previously charged service.

20. The method according to claim 11, wherein the providing of the identification information comprises providing the identification information to a credit card company server.
